(19) United States
(12) Patent Application Publication
(10) Pub. No.: US 2026/0172712 A1
(43) Pub. Date: Jun. 18, 2026

(54) IMAGE SENSORS WITH PIXEL ARRANGEMENTS HAVING MULTI-GATE TRANSFER STRUCTURES

(71) Applicant: OMNIVISION TECHNOLOGIES, INC., Santa Clara, CA (US)

(72) Inventor: Woon II Choi, Sunnyvale, CA (US)

(21) Appl. No.: 18/979,432

(22) Filed: Dec. 12, 2024

(51) Int. Cl. H04N 25/771; H04N 25/51

(52) U.S. Cl. CPC H04N 25/771; H04N 25/51

(57) ABSTRACT

Image sensors with pixel arrangements having multi-gate transfer structures are disclosed herein. In one embodiment, a pixel arrangement includes a plurality of pixels, a floating diffusion, and a transfer center gate (TCG) transistor. Each of the pixels can include a photosensor configured to photogenerate image charge in response to incident light, and a transfer transistor coupled to the photosensor. The floating diffusion can be configured to receive the image charge from the pixels. The TCG transistor can selectively couple the transfer transistor of each of the pixels to the floating diffusion. The transfer transistor of each of the pixels can be configured to selectively couple the photosensor of a respective one of the pixels to the TCG transistor. In some embodiments, the pixel arrangement further includes an outgoing gate (OG) transistor selectively coupling the TCG transistor to the floating diffusion.

### TECHNICAL FIELD

This disclosure relates generally to image sensors, and in particular but not exclusively, relates to complementary metal oxide semiconductor (CMOS) image sensors.

### BACKGROUND

Image sensors have become ubiquitous and are now widely used in digital cameras, cellular phones, security cameras, as well as medical, automobile, and other applications. As image sensors are integrated into a broader range of electronic devices, it is desirable to enhance their functionality, performance metrics, and the like in as many ways as possible (e.g., resolution, power consumption, dynamic range, etc.) through both device architecture design as well as image acquisition processing.

A typical image sensor operates in response to image light from an external scene being incident upon the image sensor. The image sensor includes an array of pixels having photosensitive elements (e.g., photodiodes) that absorb a portion of the incident image light and generate image charge upon absorption of the image light. The image charge photogenerated by the pixels may be measured as analog output image signals on column bitlines that vary as a function of the incident image light. In other words, the amount of image charge generated is proportional to the intensity of the image light, which is read out as analog image signals from the column bitlines and converted to digital values to provide information that is representative of the external scene.

### BRIEF DESCRIPTION OF THE DRAWINGS

Non-limiting and non-exhaustive embodiments of the present technology are described below with reference to the following figures, in which like or similar reference numbers are used to refer to like or similar components throughout unless otherwise specified.

FIG. 1 is a partially schematic diagram of an imaging system including a pixel array, each configured in accordance with various embodiments of the present technology.

FIG. 2 is a partially schematic circuit diagram of a pixel arrangement configured in accordance with various embodiments of the present technology.

FIG. 3 is a timing diagram illustrating a method of operating the pixel arrangement of FIG. 2 in accordance with various embodiments of the present technology.

FIG. 4 is a timing diagram illustrating another method of operating the pixel arrangement of FIG. 2 in accordance with various embodiments of the present technology.

Skilled artisans will appreciate that elements in the figures are illustrated for simplicity and clarity and are not necessarily drawn to scale. For example, the dimensions of some of the elements in the figures may be exaggerated relative to other elements to aid in understanding of various aspects of the present technology. In addition, common but well-understood elements or methods that are useful or necessary in a commercially feasible embodiment are often not depicted in the figures, or described in detail below, to avoid unnecessarily obscuring the description of various aspects of the present technology.

### DETAILED DESCRIPTION

The present disclosure relates to image sensors with multi-gate transfer structures, and to associated systems, devices, and methods. For example, several embodiments of the present technology are directed to image sensors that can be operated to provide various conversion gains with relatively low noise. Such image sensors can include a plurality of pixels, with one or more of the pixels sharing a multi-gate transfer structure to facilitate switching between the various operating modes of the image sensors. In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

It will be understood that, although the terms first, second, third, etc., may be used in the disclosure and claims to describe various elements, these elements should not be limited by these terms and should not be used to determine the process sequence or formation order of associated elements. Unless otherwise indicated, these terms are merely used to distinguish one element from another element. Thus, a first element discussed below could be termed a second element without departing from the teachings of the disclosed embodiments.

It is appreciated that the term “photosensor” or “photodiode” may correspond to a doped region disposed within the semiconductor material configured to photogenerate image charge(s) (e.g., one or more electrons or holes) in response to incident light. For example, photodiode may correspond to an n-doped region disposed within a p-type semiconductor material or an n-doped region surrounded by a p-type well disposed within the semiconductor material or a p-doped region disposed within an n-type semiconductor.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

### A. OVERVIEW

Image sensors having pixels arrangements with multi-gate transfer structures (and associated systems, devices, and methods) are disclosed. For example, several embodiments of the present technology are directed to various imaging systems with pixel arrangements that can be operated in various conversion gain modes with relatively low noise. Although normal image sensors offer great image capturing capabilities, one of the limitations with normal image sensors is that normal image sensors do not provide sufficiently low noise binning capabilities that may be useful in a variety of applications, particularly in low light settings. Attempts to provide typical image sensors with such low noise binning capabilities have resulted in compromised solutions that provide poor quality image captures compared to their normal image sensor counterparts.

It is appreciated that circuit designs configured in accordance with various embodiments of the present technology address at least some of the issues discussed above. For example, a pixel arrangement disclosed herein can include a transfer center gate (TCG) transistor and an outgoing gate (OG) transistor that are shared between multiple pixels or sub-pixels. The TCG and OG transistors can be used to control the flow of image charge(s) from each of the pixels/sub-pixels to a floating diffusion from which the image charge(s) can be read out as signals onto a bitline. Also, during readout periods, the TCG and OG transistors, along with other transistors included in the pixel circuit, can be used to modulate a conversion gain of the pixel arrangement. For example, by selectively activating or deactivating various transistors of the pixel arrangement, a suitable conversion gain mode can be selected from among multiple different conversion gain modes (e.g., based on the degree of luminance of incident light).

Thus, as will be shown and described in the various examples below, a pixel arrangement configured in accordance with some embodiments of the present technology can include a plurality of pixels (e.g., four pixels), a floating diffusion, and a transfer center gate (TCG) transistor. Each of the plurality of pixels can include a photosensor configured to photogenerate one or more image charges in response to incident light, and a transfer transistor coupled to the photosensor. The floating diffusion can be configured to receive the one or more image charges from the plurality of pixels. The TCG transistor can selectively couple the transfer transistor of each of the plurality of pixels to the floating diffusion. The transfer transistor of each of the plurality of pixels can be configured to selectively couple the photosensor of a respective one of the plurality of pixels to the TCG transistor. In some embodiments, the pixel arrangement further includes an outgoing gate (OG) transistor selectively coupling the TCG transistor to the floating diffusion. One or more of the pixels can additionally include a lateral overflow integration capacitor (LOFIC), an overflow gate (OFG) transistor, and a lateral flow gate (LFG) transistor. The pixel arrangement can further include one or more dual floating diffusion (DFD) transistors, each coupled between two adjacent pixels. Each of the transistors can be usable to modulate a conversion gain of the pixel circuit.

A method for operating a pixel arrangement can include, during an exposure period, photogenerating, using a photosensor of a pixel of the pixel arrangement, one or more image charges in response to incident light. The method can further include, during a readout period, reading out a signal level signal from the pixel arrangement. Reading out the signal level signal can include transferring the one or more image charges to a floating diffusion of the pixel arrangement coupled to the photosensor. Transferring the image charge(s) to the floating diffusion can include (i) activating a transfer transistor of the pixel selectively coupling the photosensor to a transfer center gate (TCG) transistor of the pixel arrangement and (ii) activating the TCG transistor.

The present technology is expected to offer several advantages. For example, the present technology is expected to provide controlled transfer of image charge(s) from pixels to readout circuitry, which is expected to (a) facilitate selecting a suitable conversion gain mode from a group of possible conversion gain modes, (b) facilitate binned and non-binned readouts, and (c) enable high dynamic range (HDR) imaging. The TCG and OG transistors, in particular, can facilitate such transfer of image charges with sequential activation and deactivation for achieving very high conversion gain. Additionally, or alternatively, for low conversion gain, the TCG and OG transistors can be simultaneously activated (e.g., via biasing control) to increase effective capacitance of a floating diffusion. Furthermore, pixel arrangements of the present technology can be used in 2×2 global shutter implementations without storage voltage budget loss. It is appreciated the term “simultaneously” used herein when referring to operations (e.g., signal or voltage biasing to turn on or off transistors) are ideally simultaneous but may not necessarily be exactly simultaneous due to inherent or necessary circuitry delays in signal transmission (e.g., due to physical characteristics and/or tolerances of circuitry components) as known by one of ordinary skill in the art. Moreover, pixel arrangements of the present technology can be implemented in LOFIC-based pixels. As still another advantage, pixel arrangements of the present technology can be used in a wide range of applications, including mobile applications, automotive applications, and security applications, among other applications.

### B. SELECTED EMBODIMENTS OF IMAGING SENSORS WITH MULTI-GATE TRANSFER STRUCTURES, AND ASSOCIATED SYSTEMS, DEVICES, AND METHODS

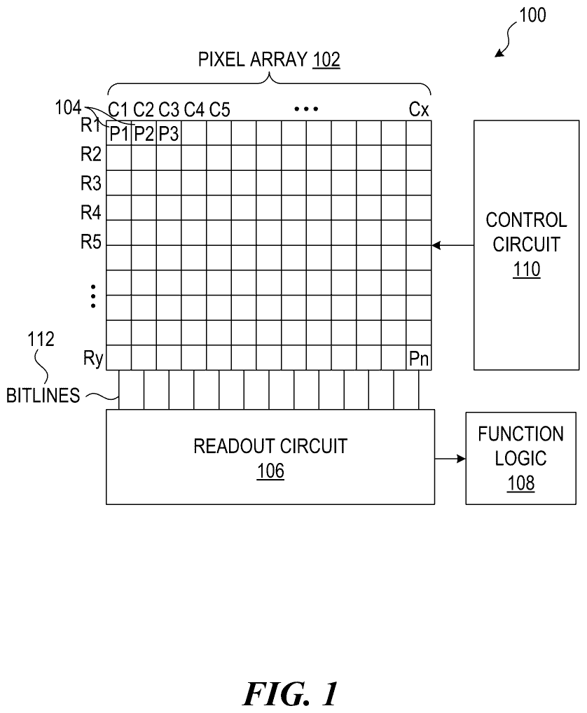

FIG. 1 is a partially schematic diagram of an imaging system 100 configured in accordance with various embodiments of the present technology. The imaging system 100 includes a pixel array 102, bitlines 112, a control circuit 110, a readout circuit 106, and function logic 108. In one example, pixel array 102 is a two-dimensional (2D) array including a plurality of pixel circuits 104 (e.g., P1, P2, P3, . . . , Pn) that are arranged into rows (e.g., R1 to Ry) and columns (e.g., C1 to Cx) to acquire image data of a person, place, object, etc., which can then be used to render an image of a person, place, object, etc. In various examples, the pixel circuits P1, P2, P3, . . . , Pn include photosensors (e.g., photodiodes) that are configured to provide image data.

In various examples, the readout circuit 106 may be configured to read out the image data through the column bitlines 112. As will be discussed, in the various examples, readout circuit 106 may include an analog-to-digital converter (ADC) (not shown) in accordance with the teachings of the present disclosure. In the example, digital image data values generated by the analog to digital converters in readout circuit 106 may then be received by function logic 108. Function logic 108 may simply store the digital image data or even manipulate the digital image data by applying post image effects (e.g., crop, rotate, remove red eye, adjust brightness, adjust contrast, or otherwise).

In one example, control circuit 110 is coupled to pixel array 102 to control operation of the plurality of photodiodes in pixel array 102. For example, control circuit 110 may generate a rolling shutter or a shutter signal for controlling image acquisition. In other examples, image acquisition is synchronized with lighting effects such as a flash.

In one example, imaging system 100 is implemented on a single semiconductor wafer. In another example, imaging system 100 is on stacked semiconductor wafers. For example, the pixel array 102 can be implemented on a pixel wafer or a sensor wafer, and the readout circuit 106, control circuit 110, and function logic 108 can be implemented on an application specific integrated circuit (ASIC) or a logic wafer, where the pixel wafer and the ASIC wafer are stacked and interconnected by bonding (hybrid bonding, oxide bonding, and/or the like) or one or more through substrate vias (TSVs). For another example, the pixel array 102 and control circuit 110 can be implemented on a pixel wafer, and an array of capacitors, the readout circuit 106, and function logic 108 can be implemented on an ASIC wafer, where the pixel wafer and the ASIC wafer are stacked and interconnected by bonding (hybrid bonding, oxide bonding, and/or the like) or one or more through substrate vias (TSVs). In another example, portions of each pixel 104, including for example the first and second photosensors, the transfer transistors, the transfer center gate transistor, the overflow transistors, and the OG transistor can be included in a first wafer, the array of capacitors, the lateral flow gate (LFG) transistors, and dual floating diffusion (DFD) transistors can be included in a second wafer, and the control circuitry and ASIC circuitry can be included in a third wafer that is stacked with the first and second wafers, etc. These and other circuit components are described in further detail herein.

In one example, imaging system 100 may be included in a digital camera, cell phone, laptop computer, an endoscope, a security camera, or an imaging device for automobile, and/or the like. Additionally, imaging system 100 may be coupled to other pieces of hardware such as a processor (general purpose or otherwise), memory elements, output (USB port, wireless transmitter, HDMI port, etc.), lighting/flash, electrical input (keyboard, touch display, track pad, mouse, microphone, etc.), and/or display. Other pieces of hardware may deliver instructions to imaging system 100, extract image data from imaging system 100, or manipulate image data supplied by imaging system 100.

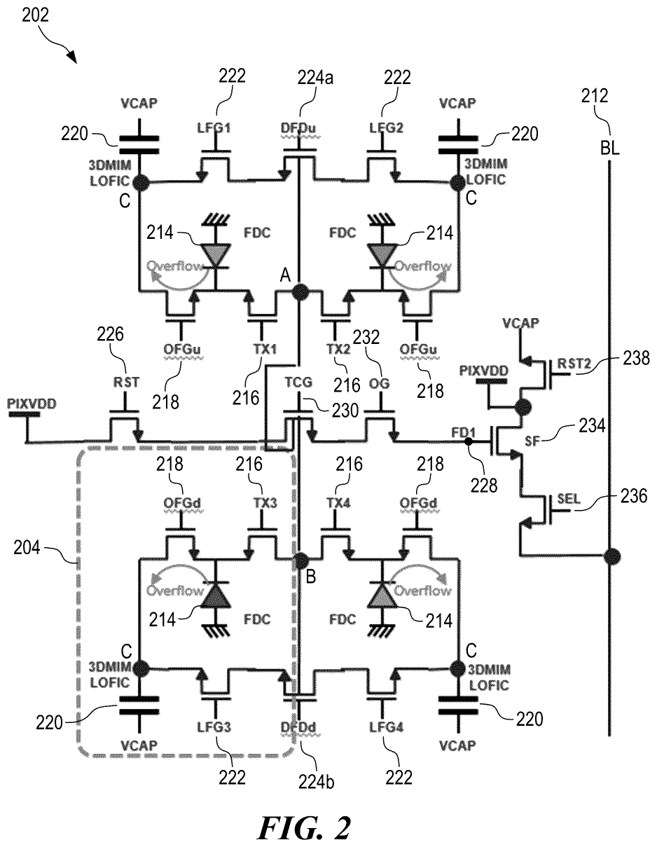

FIG. 2 is a partially schematic circuit diagram of a portion of a pixel arrangement 202 configured in accordance with various embodiments of the present technology. It is appreciated that the pixel arrangement 202 of FIG. 2 may be an example of the pixel array 102 (or a portion thereof) included in the imaging system 100 of FIG. 1, and that similarly named and numbered elements described above are coupled and function similarly below.

In the illustrated embodiment, the pixel arrangement 202 includes a plurality of pixel circuits 204, for example four pixel circuits 204 (only one of which is labeled in FIG. 2). It is appreciated that each pixel circuit 204 may be an example of one of the pixel circuits 104 of FIG. 1, or of other pixel circuits configured in accordance with the present technology. In the illustrated embodiment, the pixel circuits 204 are arranged in a 2×2 configuration. As shown, each pixel circuit 204 (“pixel 204”) can include a photosensor 214 (e.g., a photodiode) and a transfer transistor 216. In these and other embodiments, each pixel circuit 204 can further include a lateral overflow integration capacitor (LOFIC) 220, an overflow gate (OFG) transistor 218, and a lateral flow gate (LFG) transistor 222. Alternatively, the LOFIC 220, the OFG transistor 218, and/or the LFG transistor 222 can be omitted from one or more of the pixel circuits 204.

The transfer transistor 216 of each pixel circuit 204 can selectively couple the corresponding photosensor 214 to a node shared between two of the pixel circuits 204. For example, in the illustrated embodiment, the transfer transistors 216 of first and second pixel circuits 204 (e.g., the pixel circuits 204 having transfer transistors 216 with gates that receive respective control signals TX1 and TX2, respectively) selectively couple the corresponding photosensors 214 to node A, and the transfer transistors 216 of third and fourth pixel circuits (e.g., the pixel circuits 204 having transfer transistors 216 with gates that receive respective control signals TX3 and TX4, respectively) selectively couple the corresponding photosensors 214 to node B. In the illustrated embodiments, first and second pixel circuits 204 are arranged on the same row, and third and fourth pixel circuits 204 are arranged on the same row.

The OFG transistor 218 is positioned between the photosensor 214 and the LOFIC 220. The LOFIC 220 can be coupled between (i) a supply voltage VCAP and (ii) a node between the OFG transistor 218 and the LFG transistor 222. In some embodiments, the LOFIC 220 comprises a 3D metal-insulator-metal (MIM) capacitor or a trenched MIM capacitor.

The LFG transistor 222 can selectively couple the LOFIC 220 to a dual floating diffusion (DFD) transistor shared between two of the pixel circuits 204. For example, in the illustrated embodiment, the LFG transistors 222 of the first and second pixel circuits 204 (e.g., the pixel circuits 204 having LFG transistors 222 with gates that receive respective control signals LFG1 and LFG2, respectively) selectively couple the corresponding LOFIC 220 to a first DFD transistor 224a, and the LFG transistors 222 of the third and fourth pixel circuits 204 (e.g., the pixel circuits 204 having LFG transistors 222 with gates that receive respective control signals LFG3 and LFG4, respectively) selectively couple the corresponding LOFIC 220 to a second DFD transistor 224b.

In the illustrated embodiment, the first DFD transistor 224a is coupled to the first and second pixel circuits 204, which are arranged on the same row, and the second DFD transistor 224b is coupled to the third and fourth pixel circuits 204, which are arranged on the same row. In some embodiments, the first DFD transistor 224a may be coupled to a first metal-oxide-metal (MOM) capacitor formed from metal interconnects included in metal layers. The first DFD transistor 224b may be coupled to a second metal-oxide-metal (MOM) capacitor formed from metal interconnects included in metal layers.

As shown, the pixel arrangement 202 can further include a transfer center gate (TCG) transistor 230, an outgoing gate (OG) transistor 232, a reset (RST) transistor 226, and a floating diffusion (FD) 228. Each of the transfer transistors 216 can selectively couple a corresponding photosensor 214 to the TCG transistor 230. In turn, the TCG transistor 230 can selectively couple the transfer transistor 216 of each of the four pixel circuits 204 to the OG transistor 232, and the OG transistor 232 can selectively couple the TCG transistor 230 to the FD 228. The RST transistor 226 can selectively couple the TCG transistor 230 to a supply voltage PIXVDD.

The pixel arrangement 202 can further include shared readout circuitry. More specifically, the pixel arrangement 202 can include a source follower (SF) transistor 234, a row select transistor 236, and a second reset transistor 238. The FD 228 can be coupled to a gate of the SF transistor 234. The second reset transistor 238 can selectively couple the SF transistor 234 to the supply voltage VCAP. The SF transistor 234 is configured to output an analog image charge data signal to a bitline (BL) 212 through the row select transistor 236 upon assertion of a control signal SEL. The analog image charge data signal output onto the column bitline 212 is based at least in part on an amount of image charge(s) at the FD 228.

In some embodiments, pixel arrangement 202 does not have junctions (e.g., junction connection, doped region, traces, interconnects) between the TCG transistor 230 and one or more other elements of the pixel arrangement. For example, a drain terminal of the TCG transistor 230 can be coupled (e.g., directly coupled) to drain terminals of one or more of the transfer transistors 216 such that the pixel arrangement 202 lacks a junction extending between and electrically coupling the drain terminal of the TCG transistor 230 with the drain terminal(s) of the one or more transfer transistors 216. As a specific example, the TCG transistor 230 can share a drain terminal with the transfer transistors 216. Additionally, or alternatively, the drain terminal of the TCG transistor 230 can be coupled (e.g., directly coupled) to a source terminal of the RST transistor 226 such that the pixel arrangement 202 lacks a junction extending between and electrically coupling the drain terminal of the TCG transistor 230 with the source terminal of the RST transistor 226. As a specific example, the drain terminal of the TCG transistor 230 can be the source terminal of the RST transistor 226. In these and other embodiments, the source terminal of the TCG transistor 230 can be coupled (e.g., directly coupled) to the drain terminal of the OG transistor 232 such that the pixel arrangement 202 lacks a junction extending between and electrically coupling the source terminal of the TCG transistor 230 with the drain terminal of the OG transistor 232. As a specific example, the source terminal of the TCG transistor 230 can be the drain terminal of the OG transistor 232.

In some embodiments, the RST transistor 226 is coupled to the floating diffusion 228 through the TCG transistor 230. In other words, the RST transistor 226 is coupled to the floating diffusion 228 through a channel connection provided by the TCG transistor 230 when activated, eliminating the need for a metal connection. As such, the metal layout routing can be relaxed and the coupling capacitance associated with the floating diffusion 228 can be reduced, improving high conversion gain operation. The RST transistor 226 can be configured, for example by a control signal having a voltage level of zero), to provide an anti-blooming path for corresponding photosensor 214 included in each of the pixel circuits 204 during an exposure period so as to improve anti-blooming and reduce electrical crosstalk between adjacent pixel circuits 204.

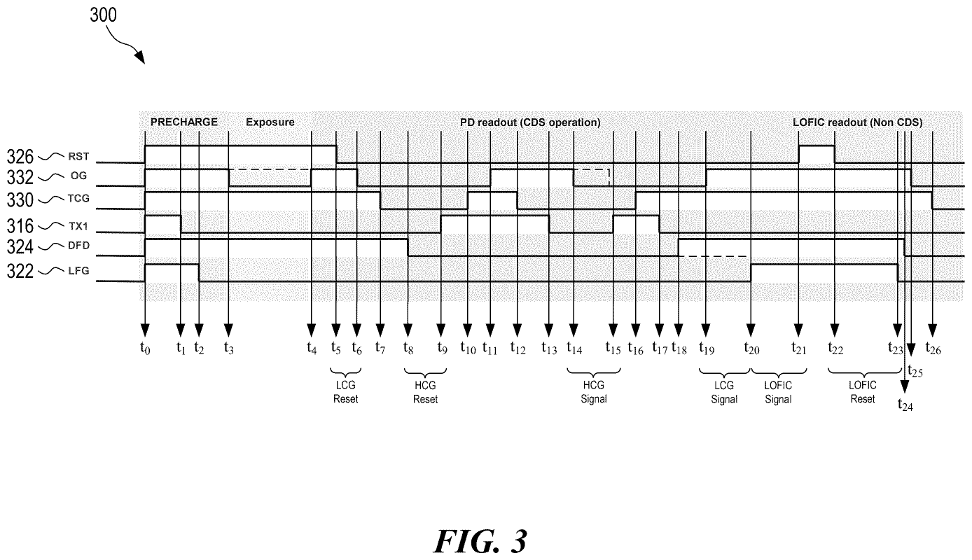

As discussed in further detail below with reference to FIG. 3, in operation, the TCG transistor 230, the OG transistor 232, the LFG transistors 222, the first DFD transistor 224a, and/or the second DFD transistor 224b can be independently toggled to operate the pixel arrangement 202 in various operating modes. The various operating modes can provide various conversion gains based on, for example, various luminance levels. The various operating modes are therefore also referred to herein as conversion gain modes.

FIG. 3 is a timing diagram 300 illustrating a method of operating the pixel arrangement 202 of FIG. 2 in accordance with various embodiments of the present technology. It is appreciated that the timing diagram 300 of FIG. 3 merely illustrates one example of operating the pixel arrangement 202, and that the pixel arrangement 202 can be operated according to different timing diagrams. Also, it is appreciated that the timing diagram 300 of FIG. 3 is not limited to controlling operation of the pixel arrangement 202, and can be used to control operation of other pixel arrangements configured in accordance with various embodiments of the present technology.

As shown, the timing diagram 300 of FIG. 3 illustrates timings of a reset control signal RST 326, an outgoing gate control signal OG 332, a transfer center gate control signal TCG 330, a transfer control signal TX1 316, a dual floating diffusion control signal DFD 324, and a lateral flow gate control signal LFG 322. Notably, the timing diagram of FIG. 3 only illustrates the controls of the transfer transistor 216 of one of the four pixel circuits 204 of FIG. 2 and of the corresponding DFD and LFG transistors 224 and 222, respectively. It is appreciated that the controls of the transfer transistors 216 of the other three pixel circuits 204 and the corresponding DFD and LFG transistors 224, 222 can be similar and/or can depend on whether the pixel circuits 204 are binned or not binned. As such, a detailed description of the other three pixel circuits 204 is largely omitted here for the sake of brevity and to avoid obscuring aspects of the present technology. Control signal TCG 330 applied to the TCG transistor can be used to configure the reset, exposure, and multi-conversion-gain charge readout operations.

Referring to FIGS. 2 and 3 together, a precharge period extends between times t₀ and t₃. At time to, control signal RST 326, control signal OG 332, control signal TCG 330, control signal TX1 316, control signal DFD 324, and control signal LFG 322 are each asserted. At time t₁, control signal TX1 316 is unasserted. At time t₂, control signal LFG 322 is unasserted. In some embodiments, control signal RST2 (not shown) is also asserted to turn on the second reset transistor 238, which can in turn reset the LOFICs 220. Therefore, during the precharge period, all components of the pixel arrangement 202, including the photosensors 214, the FD 228, and the LOFICs 220 of each pixel circuit 214 are reset to a predetermined voltage level, e.g., the supply voltage level PIXVDD.

In the illustrated embodiment, an exposure (or integration) period extends between times t₃ and t₄. At time t₃, control signal OG 332 can be either unasserted (as shown by a solid line) or kept asserted (as shown by a dashed line). Because control signal TX1 316 remains unasserted during this period, image charge(s) generated by the photosensor 214 is accumulated and stored at the photosensor 214. Any excess photogenerated image charge(s) can overflow from the photosensor 214 to the LOFIC 220 via a corresponding transfer transistor 216 and/or the OFG transistor 218. Additionally, or alternatively, the LFG transistor 222 can provide an overflow path. For example, during the exposure period, excess photogenerated image charge(s) on the LOFIC 220 can pass or otherwise overflow to the corresponding DFD transistor 224 via the LFG transistor 222. The control signal DFD 324, control signal TCG 330, and control signal RST 326 signals can be asserted with appropriate voltage levels during the exposure period. In some embodiments, excess photogenerated image charge(s) from the LOFIC 220 can be cleared or drained through a voltage supply line providing supply voltage PIXVDD along an anti-blooming path that includes the LFG transistor 222, the corresponding DFD transistor 224, the transfer transistor 216, the TCG transistor 230, and the RST transistor 226. It is appreciated that the anti-blooming path is separated from the charge transfer path from the photosensors 214 to floating diffusion 228.

In some embodiments, the pixel circuit 204 and/or the pixel arrangement 202 can include or be operated with selective conversion gain. For example, during the exposure period, an amount of image charges at the pixel circuit 204 (e.g., at the photosensor 214 and/or at the LOFIC 220) in response to incident light can be monitored. In the event that image charge(s) at the pixel circuit 204 exceeds a threshold (e.g., indicating high luminance or bright light), the pixel circuit 204 (and/or the pixel arrangement 202) can be operated in a low conversion gain mode during a subsequent readout period. Additionally, or alternatively, the LOFIC 220 can be used as part of an overflow and/or anti-blooming path, as discussed above. On the other hand, in the event that image charge(s) at the at the pixel circuit 204 does not exceed a threshold (e.g., indicating low luminance or dim light), the pixel circuit 204 (and/or the pixel arrangement 202) can be operated in a high conversion gain mode during a subsequent readout period. In some embodiments, the pixel circuit 204 and/or the pixel arrangement 202 can use both the high conversion gain mode and the low conversion gain mode, such as to enable high dynamic range imaging. In some embodiments, the pixel circuit 204 and/or the pixel arrangement 202 can use the high conversion gain mode, the low conversion gain mode, and/or the LOFIC mode, such as to enable enhanced high dynamic range imaging. As discussed further herein, the various transistors of the pixel circuit 204 and/or pixel arrangement 202 can be independently controlled to provide desired conversion gains.

With continuing reference to FIGS. 2 and 3, a photosensor readout period extends between times t₄ and t₂₀. At time t₄, in some embodiments, control signal OG 332 is asserted to initiate a readout operation. Between times t₄ and t₅, because the OG transistor 232, the TCG transistor 230, and the RST transistor 226 are asserted, the FD 228 is coupled to a voltage source to receive the supply voltage PIXVDD and is thereby reset to the voltage supply level PIXVDD. In embodiments in which control signal OG 332 remained asserted during the exposure or integration period, the FD 228 may be continuously reset between times t₀ and t₅ as control signal RST 326 remains asserted during this period.

At time t₅, control signal RST 326 is unasserted (e.g., with voltage level of zero or negative). Between times t₅ and t₆, a first reset level signal can be sampled at a second conversion gain by activating the row select transistor 236 (the corresponding row select control signal SEL is not shown in FIG. 3), converting the image signal to a digital signal (e.g., using the ADC included in the readout circuit 106 of FIG. 1), and holding the value in memory (not shown). In some embodiments, the first reset level signal comprises a low conversion gain (LCG) reset level signal. At time t₆, control signal OG 332 is unasserted, and at time t₇, control signal TCG 330 is unasserted. Thus, image charge(s) can be redistributed within the pixel arrangement 202 between times t₆ and t₈, for example, held within the FD 228.

At time t₈, control signal DFD 324 is unasserted. Between times t₈ and t₉, a second reset level signal can be sampled at a first conversion gain by activating the row select transistor 236, converting the signal to a digital signal (e.g., using the ADC included in the readout circuit 106 of FIG. 1), and holding the value in memory. In some embodiments, the second reset level signal comprises a high conversion gain (HCG) reset level signal.

At time t₉, control signal TX1 316 is asserted (e.g., transfer control signal with positive voltage level), forming a channel between the photosensor 214 of first pixel circuit and node A. This enables image charge(s) photogenerated by (and stored at) the photosensor 214 to flow or transfer across the transfer transistor 216 to the TCG transistor 230. At time t₁₀, control signal TCG 330 is asserted. This enables the image charge(s) to flow across the TCG transistor 230 and to the OG transistor 232. At time t₁₁, control signal OG 332 is asserted. This enables the image charge(s) to flow across the OG transistor 232 and to the FD 228.

At time t₁₂, control signal TCG 330 is unasserted. At time t₁₃, control signal TX1 316 is unasserted. At time t₁₄, control signal OG 332 can be either unasserted or kept asserted depending on an effective capacitance of floating diffusion needed for selected conversion gain. In embodiments in which control signal OG 332 is kept asserted, control signal OG 332 can be unasserted closer to time t₁₅.

Between times t₁₄ and t₁₅, a first signal level signal can be sampled by activating the row select transistor 236 at the first conversion gain, converting the image signal to a digital signal (e.g., using the ADC included in the readout circuit 106 of FIG. 1), and holding the value in memory. In some embodiments, the first signal level signal comprises an HCG signal level signal.

At time t₁₅, control signal TX1 316 is asserted. This allows additional image charge(s) photogenerated by and stored at the photosensor 214 to flow across the transfer transistor 216 to the TCG transistor 230. At time t₁₆, control signal TCG 330 is asserted. This enables the additional image(s) charge to flow across the TCG transistor 230 to the OG transistor 232. At time t₁₇, control signal TX1 316 is unasserted (e.g., with a voltage signal of a negative voltage level). At time t₁₈, control signal DFD 324 can be either kept unasserted or asserted. In embodiments in which DFD 324 is asserted, image charge(s) that crossed the LFG transistor 222 from the LOFIC 220 along the overflow path can flow to the OG transistor 232. This results in accumulation of (a) image charge(s) transferred to the OG transistor 232 via the transfer transistor 216 at times t₁₅ and t₁₆ and (b) image charge(s) transferred from the LOFIC to the OG transistor 232 via the LFG transistor 222 and the corresponding DFD transistor 224.

At time t₁₉, control signal OG 332 is asserted. This allows the image charge(s) at the OG transistor 332 to flow to the FD 228 via the OG transistor 332. Between times t₁₉ and t₂₀, a second signal level signal can be sampled at the second conversion gain by activating the row select transistor 236, converting the signal to a digital signal (e.g., using the ADC included in the readout circuit 106 of FIG. 1), and holding the value in memory. In some embodiments, the second signal level signal comprises a LCG signal level signal.

In some embodiments, image charge(s) stored on the LOFIC can be readout. For example, in the illustrated embodiment, a LOFIC readout period extends between times t₂₀ and t₂₆. At time t₂₀, control signal LFG 322 is asserted. In embodiments in which control signal DFD 324 is kept unasserted at time t₁₈, control signal DFD 324 can also be asserted at time t₂₀. This allows image charge(s) stored on the LOFIC 220 to flow across the LFG transistor 222, the corresponding DFD transistor 224, the TCG transistor 230, and the OG transistor 232 to reach the FD 228. Control signal TX1 316 can remain unasserted during this period, inhibiting further image charge(s) photogenerated by the photosensor 214 from flowing toward the FD 228 via the transfer transistor 216. Between times t₂₀ and t₂₁, a LOFIC signal level signal can be sampled at a third conversion gain by activating the row select transistor 236, converting the signal to a digital signal (e.g., using the ADC included in the readout circuit 106 of FIG. 1), and holding the value in memory.

At time t₂₁, control signal RST 326 is asserted. Between times t₂₁ and t₂₂, (i) the LOFIC 220 can be reset via the LFG transistor 222, the corresponding DFD transistor 224, the TCG transistor 230, and the RST transistor 226, and (ii) the FD 228 can be reset via the OG transistor 232, the TCG transistor 230, and the RST transistor 226. At time t₂₂, control signal RST 326 is unasserted. Between times t₂₂ and t₂₃, a LOFIC reset level signal at the third conversion gain can be sampled by activating the row select transistor 236, converting the signal to a digital signal (e.g., using the ADC included in the readout circuit 106 of FIG. 1), and holding the value in memory. At time t₂₃, control signal LFG 322 is unasserted. At time t₂₄, control signal DFD 324 is unasserted. At time t₂₅, control signal OG 332 is unasserted. At time t₂₆, control signal TCG 330 is unasserted.

As previously mentioned, the timings of control signals associated with the other three pixel circuits 204 of the pixel arrangement 202 can depend on, for example, whether the pixel arrangement 202 is operated in a binning or non-binning mode. For example, in a 2×2 (4C) binning mode, during the photosensor readout period, the transfer transistors 216 of the four pixel circuits 204 can be activated such that image charge(s) photogenerated by the photosensors 214 of the four pixel circuits 204 can be binned/aggregated and read out from the pixel arrangement 202 together. As another example, any two or any three of the transfer transistors 216 from amongst the four transfer transistors 216 of the pixel arrangement 202 can be activated such that image charge(s) photogenerated by the corresponding two or three photosensors 214 can be binned/aggregated and read out from the pixel arrangement 202 together. On the other hand, in a non-binning mode, during the photosensor readout period, each of the transfer transistors 216 of the four pixel circuits 204 can be activated one at a time such that image charge(s) photogenerated by each corresponding photosensor can be read out of the pixel arrangement 202 as separate signals.

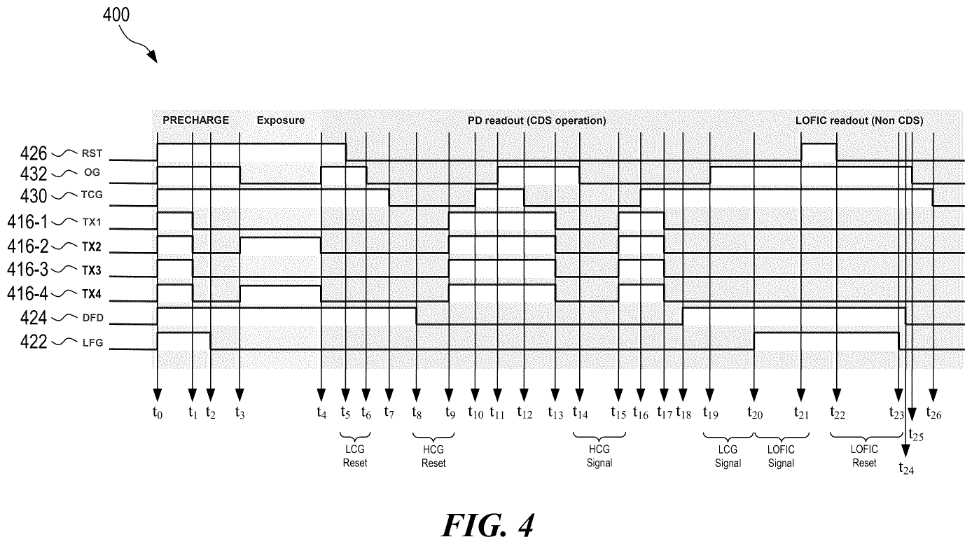

After the reset level signals and signal level signals have been read out from the pixel arrangement 202, correlated double sampling (CDS) can be used to reduce (or factor out) noise from the signal level signals. For example, the LCG reset level signal sampled between times t₅ and t₆ can be subtracted from the LCG signal level signal sampled between times t₁₉ and t₂₀ to obtain an LCG image signal. As another example, the HCG reset level signal sampled between times t₈ and t₉ can be subtracted from the HCG signal level signal sampled between times t₁₄ and t₁₅ to obtain an HCG image signal. In some embodiments, the LOFIC reset level signal sampled between times t₂₂ and t₂₃ can be subtracted from the LOFIC signal level signal sampled between times t₂₀ and t₂₁ to obtain a LOFIC image signal. In these and other embodiments, the LOFIC image signal sampled between times t₂₀ and t₂₁ and the LOFIC reset level signal sampled between times t₂₂ and t₂₃ can be used for offset correction, dark current compensation, and/or the like. FIG. 4, described below, illustrates an alternative timing diagram and alternative use of the LOFIC image and reset level signals.

As described above, the TCG transistor 230, the OG transistor 232, and/or other transistors included in the pixel arrangement 202 are usable to modulate a conversion gain mode of the pixel arrangement 202. Table 1 below lists six different combinations of activating or deactivating each of the LFG transistor 222, the DFDu transistor 224a, the DFDd transistor 224b, the TCG transistor 230, and the OG transistor 232 to enable various conversion gain modes of the pixel arrangement 202. Table 1 below also indicates, for each of the six combinations, the corresponding conversion gain mode. Although multiple ones of the six combinations may be listed under the same conversion gain mode (e.g., three combinations are listed under LCG in Table 1 below), it is appreciated different combinations can provide different conversion gain levels. For example, going from top to bottom across Table 1 below, the first combination can provide a first conversion gain level, the second combination can provide a second conversion gain level less than the first conversion gain level, the third combination can provide a third conversion gain level less than the second conversion gain level, the fourth combination can provide a fourth conversion gain level less than the third conversion gain level, the fifth combination can provide a fifth conversion gain level less than the fourth conversion gain level, and the sixth combination can provide a sixth conversion gain level less than the fifth conversion gain level. The first conversion gain level and the second conversion gain level may be considered levels under a high conversion gain mode. The third conversion gain level, the forth conversion gain level, and the fifth conversion gain level may be considered levels under a low conversion gain mode. The sixth conversion gain level may be considered a level under a LOFIC conversion gain mode.

In some embodiments, pixel arrangements configured in accordance with the present technology can utilize more than one of the conversion gain modes included in Table 1 below. For example, pixel arrangements configured in accordance with the present technology can utilize four or five of the conversion gain modes included in Table 1 below for quad conversion gain operations or penta conversion gain operations, respectively. As another example, pixel arrangements configured in accordance with various embodiments of the present technology can utilize all six of the conversion gain modes included in Table 1 below. Indeed, FIG. 3 and the corresponding description above illustrates how all six conversion gain modes included in Table 1 below can be used in the pixel arrangement 202 of FIG. 2. Thus, Table 1 below includes a column indicating where in the timing diagram 300 of FIG. 3 each conversion gain mode can be utilized. As discussed above, in some embodiments, a suitable conversion gain mode can be selected among multiple different options depending on the degree of luminance of incident light.

TABLE 1

| Conversion | Transistor Controls During Readout | |
|---|---|---|
| Gain Mode | Period | Illustration in FIG. 3 |
| HCG | Deactivated: LFG, DFDu, DFDd, TCG, OG | Between times t₈ and t₉ and/or |
| | | between times t₁₄ and t₁₅ (solid line |
| | | for OG) |
| | Deactivated: LFG, DFDu, DFDd, TCG | Between times t₁₄ and t₁₅ (dashed |
| | Activated: OG | line for OG) |
| LCG | Deactivated: LFG, DFDu, DFDd | Between times t₁₉ and t₂₀ (solid line |
| | Activated: TCG, OG | for both DFDu and DFDd) |
| | Deactivated: LFG, DFDu | Between times t₅ and t₆ and/or |
| | Activated: DFDd, TCG, OG | between times t₁₉ and t₂₀ (solid line |
| | | for DFDd and dashed line for |
| | | DFDu) |
| | Deactivated: LFG | Between times t₅ and t₆ and/or |
| | Activated: DFDu, DFDd, TCG, OG | between times t₁₉ and t₂₀ (dashed |
| | | line for both DFDu and DFDd) |
| LOFIC | Activated: LFG, DFDu, DFDd, TCG, OG | Between times t₂₀ and t₂₁ and |
| | | between times t₂₂ and t₂₃ |

FIG. 4 is a timing diagram 400 illustrating a method of operating the pixel arrangement 202 of FIG. 2 in accordance with various embodiments of the present technology. It is appreciated that the timing diagram 400 of FIG. 4 merely illustrates one example of operating the pixel arrangement 202, and that the pixel arrangement 202 can be operated according to different timing diagrams. Also, it is appreciated that the timing diagram 400 of FIG. 4 is not limited to controlling operation of the pixel arrangement 202, and can be used to control operation of other pixel arrangements configured in accordance with various embodiments of the present technology.

As shown, the timing diagram 400 of FIG. 4 illustrates timings of a reset control signal RST 426, an outgoing gate control signal OG 432, a transfer center gate control signal TCG 430, a first transfer control signal TX1 416-1, a second transfer control signal TX2 416-2, a third transfer control signal TX3 416-3, a fourth transfer control signal TX4 416-4, a dual floating diffusion control signal DFD 424, and a lateral flow gate control signal LFG 422. Notably, the timing diagram of FIG. 4 only illustrates the controls of one DFD transistor and one LFG transistor. It is appreciated that the controls of the other DFD transistor and other LFG transistors corresponding to the other three pixel circuits 204 can be similar and/or can depend on whether the pixel circuits 204 are binned or not binned. As such, a detailed description of the other DFD and LFG transistors is largely omitted for the sake of brevity and to avoid obscuring aspects of the present technology.

The timing diagram of FIG. 4 is similar to the timing diagram of FIG. 3. For example, the control timings illustrated in FIG. 4 are substantially similar to the corresponding control timings illustrated in FIG. 3 for a precharge period (extending between times to and t₃), a photosensor readout period (extending between times t₄ and t₂₀), and a LOFIC readout period (extending between times t₂₀ and t₂₆). Also, as shown, transfer control signals TX1 416-1, TX2 416-2, TX3 416-3, and TX4 416-4 are identical during these periods. Therefore, description of the control timings during these periods are omitted here for the sake of brevity and to avoid obscuring certain differences between the timing diagrams 300 and 400 of FIGS. 3 and 4, respectively.

As shown in the timing diagram 400, during an exposure (or integration) period (extending between times t₃ and t₄), reset control signal RST 426, transfer center gate control signal TCG 430, second transfer control signal TX2 416-2, fourth transfer control signal TX4 416-4, and dual floating diffusion control signal DFD 424 are or remain asserted. On the other hand, outgoing gate control signal OG 432, first transfer control signal TX1 416-1, third transfer control signal TX3 416-3, and lateral flow gate control signal LFG 422 are or remain unasserted. Therefore, referring to FIGS. 2 and 4 together, as the photosensors 214 of the illustrated four pixel circuits 204 photogenerate image charge(s) in response to incident light during the exposure period, (i) image charge(s) photogenerated in the first and third pixel circuits 204 accumulate at the photosensors 214 of the first and third pixel circuits 204 (because first transfer control signal TX1 416-1 and third transfer control signal TX3 416-3 are unasserted) and (ii) image charge(s) photogenerated in the second and fourth pixel circuits 204 are constantly and continuously cleared from the pixel arrangement 202 along corresponding paths including the transfer transistors 216 of the second and fourth pixel circuits 204, the TCG transistor 230, and the reset transistor 226 (because reset control signal RST 426, transfer center gate control signal TCG 430, second transfer control signal TX2 416-2, and fourth transfer control signal TX4 416-4 are asserted). During the exposure period, image charge(s) at the photosensors 214 of the first and third pixel circuits 204 may also overflow through a corresponding to OFG transistor 218 to a corresponding LOFIC 220 of the first and third pixel circuits 204. Therefore, at the end of the exposure period, the LOFICs 220 of the first and third pixel circuits 204 may store overflow image charge(s) from the corresponding photosensors 214 while the LOFICs 220 of the second and fourth pixel circuits 204 do not.

Continuing with this example, signals read out from the LOFICs 220 of the second and fourth pixel circuits 204 can be used as dark current reference levels for signals read out from the LOFICs 220 of the first and third pixel circuits 204. Use of the signals read out from the LOFICs 220 of the second and fourth pixel circuits 204 as dark current reference levels is expected to cancel (or at least reduce) image lag associated with high-k MIM-based LOFICs, which can be especially apparent during bright conditions. Furthermore, as the timing diagram of FIG. 4 represents a single frame, the activation of first transfer control signal TX1 416-1, second transfer control signal TX2 416-2, third transfer control signal TX3 416-3, and fourth transfer control signal TX4 416-4 can be flipped during a subsequent frame. For example, during an exposure period of a frame immediately following the frame corresponding to the timing diagram 400 of FIG. 4, first transfer control signal TX1 416-1 and third transfer control signal TX3 416-3 can be asserted while second transfer control signal TX2 416-2 and fourth transfer control signal TX4 416-4 are unasserted. As such, signals read out from LOFICs 220 of the first and third pixel circuits 204 (as opposed to the second and fourth pixel circuits 204) can be used as dark current reference levels for signals read out form the LOFICs of the second and fourth pixel circuits 204. Accordingly, in some embodiments, the pixel circuits 204 used as the dark current reference levels can alternate between different frames.

### C. CONCLUSION

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A pixel arrangement included in a pixel array, comprising:
a plurality of pixels, each of the plurality of pixels including:
a photosensor configured to photogenerate image charge in response to incident light, and
a transfer transistor coupled to the photosensor;
a floating diffusion configured to receive the image charge from the plurality of pixels; and
a transfer center gate (TCG) transistor selectively coupling the transfer transistor of each of the plurality of pixels to the floating diffusion, wherein the transfer transistor of each of the plurality of pixels is configured to selectively couple the photosensor of a respective one of the plurality of pixels to the TCG transistor.

2. The pixel arrangement of claim 1, further comprising an outgoing gate (OG) transistor selectively coupling the TCG transistor to the floating diffusion.

3. The pixel arrangement of claim 2, wherein the TCG transistor and the OG transistor are usable to modulate a conversion gain level for a signal readout of the pixel arrangement.

4. The pixel arrangement of claim 2, wherein the OG transistor includes a drain that is directly coupled to a source of the TCG transistor without a junction.

5. The pixel arrangement of claim 1, wherein the transfer transistor of each of the plurality of pixels includes a drain that is directly coupled to a drain of the TCG transistor without a junction.

6. The pixel arrangement of claim 1, further comprising a reset transistor selectively coupling the TCG transistor to a supply voltage.

7. The pixel arrangement of claim 6, wherein the TCG transistor is coupled between the reset transistor and the floating diffusion, and the reset transistor includes a source that is directly coupled to a drain of the TCG transistor without a junction.

8. The pixel arrangement of claim 1, wherein each of the plurality of pixels further includes (a) a lateral overflow integration capacitor (LOFIC) configured to receive overflow image charge from the photosensor of a respective one of the plurality of pixels, and (b) an overflow gate (OFG) electrically positioned between the photosensor of the respective one of the plurality of pixels and the LOFIC.

9. The pixel arrangement of claim 1, wherein:
the plurality of pixels includes four pixels,
each of the four pixels further includes (a) a lateral overflow integration capacitor (LOFIC) configured to receive overflow image charge from the photosensor of a respective one of the four pixels and (b) a lateral flow gate (LFG) transistor coupled between the photosensor and the LOFIC, and
the pixel arrangement further comprises:
a first dual floating diffusion (DFD) transistor selectively coupling the LFG transistor of a first one of the four pixels to the LFG transistor of a second one of the four pixels, wherein the first one of the four pixels and the second one of the four pixels are arranged on a first row of the pixel array, and
a second DFD transistor selectively coupling the LFG transistor of a third one of the four pixels to the LFG transistor of a fourth one of the four pixels, wherein the third one of the four pixels and the fourth one of the four pixels are arranged on a second row of the pixel array different from the first row.

10. The pixel arrangement of claim 9, wherein the TCG transistor, the first DFD transistor, and the second DFD transistor are usable to modulate a conversion gain level of the pixel arrangement.

11. A method for operating a pixel arrangement, the method comprising:
during an exposure period—
photogenerating, using a photosensor of a pixel of the pixel arrangement, one or more image charges in response to incident light; and
during a readout period occurring after the exposure period—
reading out a signal level signal from the pixel arrangement, wherein the signal level signal corresponds to the one or more image charges, wherein reading out the signal level signal includes transferring the image charge to a floating diffusion of the pixel arrangement, and wherein transferring the one or more image charge to the floating diffusion includes (i) activating a transfer transistor of the pixel selectively coupling the photosensor to a transfer center gate (TCG) transistor of the pixel arrangement, and (ii) activating the TCG transistor.

12. The method of claim 11, wherein transferring the one or more image charges to the floating diffusion includes activating an outgoing gate (OG) transistor selectively coupling the TCG transistor to the floating diffusion.

13. The method of claim 11, wherein reading out the signal level signal further includes reading out the signal level signal from the pixel arrangement at a first conversion gain level while (i) an outgoing gate (OG) transistor selectively coupling the TCG transistor to the floating diffusion is activated and (ii) the transfer transistor and the TCG transistor are simultaneously deactivated.

14. The method of claim 11, wherein reading out the signal level signal further includes reading out the signal level signal from the pixel arrangement while (i) an outgoing gate (OG) transistor selectively coupling the TCG transistor to the floating diffusion, (ii) the transfer transistor, and (iii) the TCG transistor are simultaneously deactivated.

15. The method of claim 13, wherein reading out the signal level signal further includes reading out the signal level signal from the pixel arrangement at a second conversion gain level that is less than the first conversion gain level while (i) the TCG transistor and an outgoing gate (OG) transistor selectively coupling the TCG transistor to the floating diffusion are simultaneously activated and (ii) the transfer transistor is deactivated.

16. The method of claim 15, wherein:
the pixel further includes a lateral overflow integration capacitor (LOFIC) selectively coupled to the TCG transistor via a dual floating diffusion (DFD) transistor of the pixel arrangement; and
reading out the signal level signal further includes reading out the signal level signal at a third conversion gain level that is less than the second conversion gain level while the DFD transistor is activated.

17. The method of claim 15, wherein:
the pixel further includes a lateral overflow integration capacitor (LOFIC) selectively coupled to the TCG transistor via a dual floating diffusion (DFD) transistor of the pixel arrangement; and
reading out the signal level signal further includes reading out the signal level signal at a fourth conversion gain level that is greater than the low conversion gain level while the DFD transistor is deactivated.

18. The method of claim 11, further comprising resetting the floating diffusion, wherein resetting the floating diffusion includes (i) activating the TCG transistor and a reset transistor of the pixel arrangement while (ii) the transfer transistor is deactivated.

19. The method of claim 11, further comprising reading out a reset level signal at first conversion gain from the pixel arrangement, wherein reading out the reset level signal includes reading out the reset level signal while the TCG transistor and the transfer transistor are simultaneously deactivated.

20. The method of claim 19, wherein reading out the reset level signal further includes reading out the reset level signal at a second conversion gain less than the first conversion gain while (i) an outgoing gate (OG) transistor selectively coupling the TCG transistor to the floating diffusion, (ii) the transfer transistor, and (iii) the TCG transistor are simultaneously deactivated.

21. The method of claim 11, further comprising reading out a reset level signal from the pixel arrangement, wherein reading out the reset level signal at a third conversion gain includes reading out the reset level signal while the TCG transistor is activated and the transfer transistor is deactivated.

22. The method of claim 21, wherein reading out the reset level signal further includes reading out the reset level signal at a fourth conversion gain by activating an outgoing gate (OG) transistor to selectively couple the TCG transistor to the floating diffusion.

23. The method of claim 22, wherein:
the pixel further includes a lateral overflow integration capacitor (LOFIC) selectively coupled to the TCG transistor via a dual floating diffusion (DFD) transistor of the pixel arrangement; and
reading out the reset level signal further includes reading out the signal level signal while the DFD transistor is activated.

24. The method of claim 11, wherein:
the pixel further includes a lateral overflow integration capacitor (LOFIC) selectively coupled to the TCG transistor via a dual floating diffusion (DFD) transistor of the pixel arrangement;
the method further comprises resetting the LOFIC; and
resetting the LOFIC includes activating a reset transistor of the pixel arrangement while (i) the TCG transistor and the DFD transistor are activated and (ii) the transfer transistor is deactivated.

25. The method of claim 11, wherein:
the pixel further includes a lateral overflow integration capacitor (LOFIC) and a lateral flow gate (LFG) transistor selectively coupling the LOFIC to a dual floating diffusion (DFD) transistor of the pixel arrangement;
the DFD transistor selectively couples the LFG transistor to the TCG transistor; and
the method further comprises, during a LOFIC readout period—
reading out a LOFIC signal level signal, wherein reading out the LOFIC signal level signal includes reading out the LOFIC signal level signal while (i) the LFG transistor, the dual floating diffusion (DFD) transistor, and the TCG transistor are simultaneously activated and (ii) the transfer transistor is deactivated,
resetting the LOFIC via the TCG transistor, and
after resetting the LOFIC, reading out a LOFIC reset level signal, wherein reading out the LOFIC reset level signal includes reading out the LOFIC reset level signal while (i) the LFG transistor, the TCG transistor, and the DFD transistor are simultaneously activated and (ii) the transfer transistor is deactivated.

26. The method of claim 11, further comprising:
the pixel is a first pixel, the transfer transistor is a first transfer transistor, the photosensor is a first photosensor, and the image charge is first image charge;
the first pixel further includes (a) a first lateral overflow integration capacitor (LOFIC) and (b) a first overflow gate (OFG) transistor positioned between the first photosensor and the first LOFIC;
the pixel arrangement further includes a second pixel different from the first pixel and including (i) a second photosensor, (ii) a second transfer transistor selectively coupling the second photosensor to the TCG transistor, (iii) a second LOFIC, and (iv) a second OFG transistor positioned between the second photosensor and the second LOFIC; and
the method further comprises:
during the exposure period—
activating the second transfer transistor, the TCG transistor, and a reset transistor of the pixel arrangement such that second image charge photogenerated by the second photosensor is cleared from the pixel arrangement; and
during a LOFIC readout period included in the readout period—
reading out a first LOFIC signal level signal from the first LOFIC, the first LOFIC signal level signal corresponding to an amount of the first image charge that transferred to the first LOFIC during the exposure period via the first OFG transistor;
reading out a second LOFIC signal level signal from the second LOFIC, the second signal level signal corresponding to an amount of the second image charge that transferred to the second LOFIC during the exposure period via the second OFG transistor; and
factoring out a metal-insulator-metal lag component of the first LOFIC signal level signal using the second signal level signal.

27. The method of claim 11, further comprising, during the exposure period, clearing overflow image charge from a lateral overflow integration capacitor (LOFIC) of the pixel, wherein clearing the overflow image charge includes activating (a) the TCG transistor, (b) a dual floating diffusion (DFD) transistor of the pixel arrangement that is electrically positioned between the LOFIC and the TCG transistor, and (c) a reset transistor of the pixel arrangement that is electrically positioned between the TCG transistor and a voltage supply.
